(19) United States
(12) Patent Application Publication
(10) Pub. No.: US 2026/0138295 A1
(43) Pub. Date: May 21, 2026

(54) ROTARY ELECTRIC SHAVER

(71) Applicant: MAXELL IZUMI CO., LTD., Matsumoto-shi (JP)

(72) Inventor: Hideaki KOIKE, Nagano (JP)

(21) Appl. No.: 19/338,000

(22) Filed: Sep. 24, 2025

(30) Foreign Application Priority Data
Nov. 20, 2024 (JP) 2024-202313

(51) Int. Cl. B26B 19/14

(52) U.S. Cl. CPC B26B 19/141

(57) ABSTRACT

A rotary electric shaver includes an outer blade having hair inlets, and an inner blade rotating while coming into sliding contact with an inner surface of the outer blade. The inner blade includes a first small blade erected from a base surface, and a second small blade erected from the base surface. A first front end blade edge is formed in a front end part of an upper end part in a rotation direction. A second front end blade edge is formed in a front end part of an upper end part. An angle of a rake angle of the first front end blade edge is relatively small and an angle of a rake angle of the second front end blade edge is relatively large.

### CROSS-REFERENCE TO RELATED APPLICATION

This application is based upon and claims the benefit of priority of the prior Japanese Patent Application No. P2024-202313, filed on Nov. 20, 2024, and the entire contents of which are incorporated herein by reference.

### TECHNICAL FIELD

The present invention relates to a rotary electric shaver.

### BACKGROUND ART

For example, a rotary electric shaver is known which includes an outer blade in which a plurality of hair inlets are formed and an inner blade rotating while coming into sliding contact with an inner surface of the outer blade. The rotary electric shaver cuts hairs entering the hair inlets (refer to PTL 1: JP-A-2007-135991).

### SUMMARY OF INVENTION

### Technical Problem

In the rotary electric shaver in the related art exemplified in PTL 1, although cutting quality of the hairs can be improved, in some cases, skin is damaged by the inner blade, thereby causing a tingling feel on the skin. In this invention, examples of the hairs include beards, mustache, whisker, and the like. Therefore, the present inventor has developed a rotary electric shaver including an inner blade that is rotatable in a forward rotation direction and a reverse rotation direction, and including a mode in which the cutting quality is satisfactory and a mode in which the tingling feel on the skin can be reduced by suppressing damage to the skin (refer to PTL 2: JP-A-2015-223315).

However, the rotary electric shaver in the related art exemplified in PTL 2 has a problem in that a mechanism is complicated to rotate the inner blade in the forward rotation direction and in the reverse rotation direction.

### Solution to Problem

The present invention is made in view of the above-described circumstances, and an object of the present invention is to provide a rotary electric shaver having a simple configuration which can improve cutting quality while suppressing damage to skin.

According to an embodiment, there is provided a rotary electric shaver including a blade unit including an outer blade in which a plurality of hair inlets are formed, and an inner blade rotating while coming into sliding contact with an inner surface of the outer blade. The inner blade includes a plurality of first small blades erected from a base surface, and a plurality of second small blades erected from the base surface. In the first small blades, a first front end blade edge configured to cut hairs entering the hair inlets is formed in a front end part of an upper end part in the rotation direction. In the second small blades, a second front end blade edge configured to cut the hairs entering the hair inlets is formed in a front end part of an upper end part in the rotation direction. An angle α1 of a rake angle of the first front end blade edge is formed to be a relatively small angle and an angle α2 of a rake angle of the second front end blade edge is formed to be a relatively large angle.

According to this configuration, the first small blade can realize a blade edge (first front end blade edge) in which an improvement in cutting quality is emphasized, and the second small blade can realize a blade edge (second front end blade edge) in which damage suppression is emphasized and cutting quality is not significantly inferior to that of the first front end blade edge.

It is preferable that the first small blade is disposed on an outer peripheral side on the base surface, the second small blade is disposed on an inner peripheral side on the base surface, and the outer blade includes a first outer blade provided at a position corresponding to the first small blade and a second outer blade provided at a position corresponding to the second small blade, an upper surface of the first outer blade is formed at a relatively high position, and an upper surface of the second outer blade is formed at a relatively low position.

In addition, it is preferable that the angle α1 is formed to satisfy 30°≤α1≤90°, and the angle α2 is formed to satisfy 70°≤α2≤90°.

It is preferable that the outer blade is formed such that a circumferential width of the hair inlet provided in the first outer blade is relatively narrow, and is formed such that a circumferential width of the hair inlet provided in the second outer blade is relatively wide.

In addition, it is preferable that the outer blade includes an outer blade cover fitted to a center position in a radial direction, and an upper surface of the outer blade cover is formed at a position lower than the upper surface of the second outer blade, and when a difference in a height dimension between the upper surface of the first outer blade and the upper surface of the second outer blade is defined as D1, and a difference in a height dimension between the upper surface of the second outer blade and the upper surface of the outer blade cover is defined as D2, the outer blade is configured to satisfy D2≤D1×3.

In addition, it is preferable that the outer blade includes an outer blade cover fitted at a center position in a radial direction, and an upper surface of the outer blade cover is formed at a position lower than the upper surface of the first outer blade and at a position higher than the upper surface of the second outer blade.

In addition, it is preferable that the first small blade is configured to be erected from the base surface at an acute angle in the rotation direction, and the second small blade is configured to be erected from the base surface at an acute angle in the direction opposite to the rotation direction.

In addition, it is preferable that the first small blade and the second small blade are formed in a forward and backward symmetrical shape along the rotation direction.

### Advantageous Effects of Invention

According to the present invention, it is possible to realize a rotary electric shaver having a simple configuration in which an inner blade rotates only in one direction, and which can improve cutting quality while suppressing damage.

### BRIEF DESCRIPTION OF DRAWINGS

FIG. 1 is a perspective view illustrating an example of a rotary electric shaver according to an embodiment of the present invention.

FIG. 2 is an exploded perspective view illustrating an example of a head unit of the rotary electric shaver in FIG. 1.

FIG. 3 is a perspective view illustrating an example of an inner blade of the rotary electric shaver in FIG. 1.

FIG. 4A is a side view illustrating an example of a first small blade of the inner blade in FIG. 3, and FIG. 4B is an enlarged view of an upper part of the first small blade in FIG. 4A.

FIG. 5A is a side view illustrating an example of a second small blade of the inner blade in FIG. 3, and FIG. 5B is an enlarged view of an upper part of the second small blade in FIG. 5A.

FIG. 6 is a perspective view illustrating an example of an outer blade of the rotary electric shaver illustrated in FIG. 1.

FIG. 7 is a plan view illustrating an example of the outer blade illustrated in FIG. 6.

FIG. 8 is an enlarged view of a part VIII in FIG. 7.

FIG. 9 is a cross-sectional view taken along line IX-IX in FIG. 7.

FIG. 10 is a perspective view illustrating an example of an outer blade cover of the rotary electric shaver illustrated in FIG. 1.

### DESCRIPTION OF EMBODIMENTS

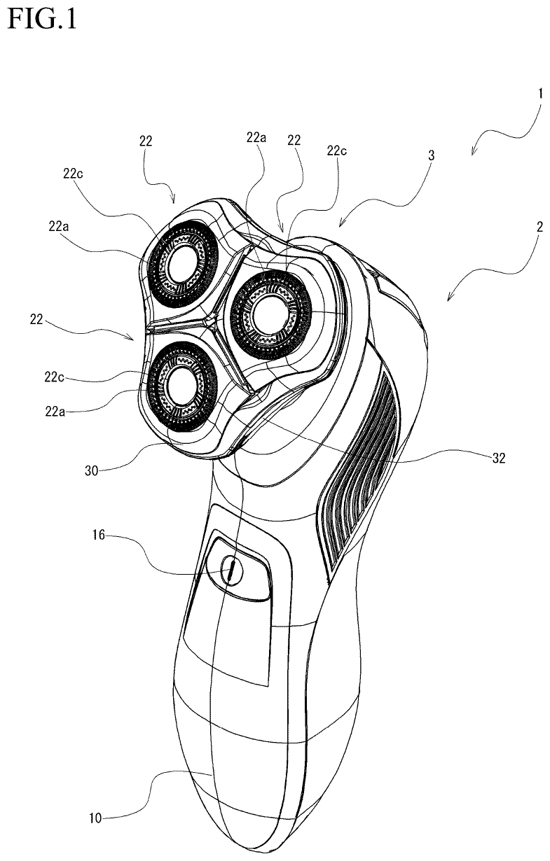

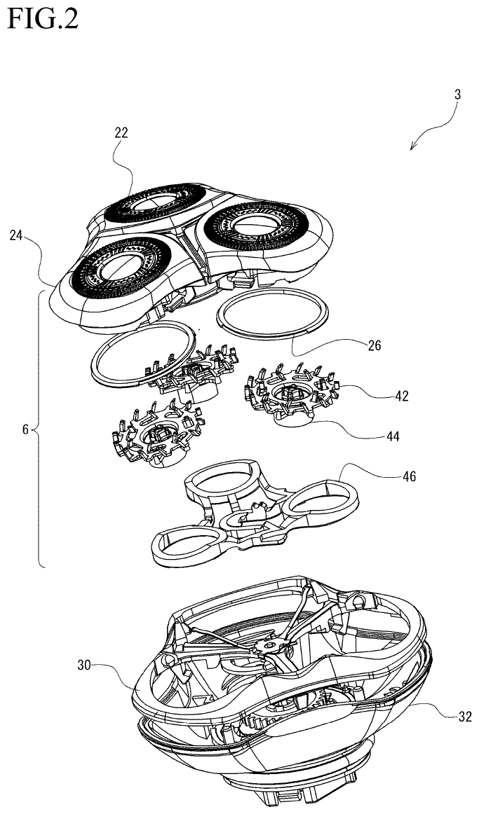

Hereinafter, an embodiment of the present invention will be described in detail with reference to the drawings. FIG. 1 is a perspective view (schematic view) illustrating an example of a rotary electric shaver 1 according to the present embodiment. In addition, FIG. 2 is an exploded perspective view (schematic view) illustrating an example of a head unit 3 of the rotary electric shaver 1. In all drawings for describing the embodiment, the same reference numerals will be assigned to members having the same function, and repeated description thereof may be omitted in some cases.

As illustrated in FIGS. 1 and 2, the rotary electric shaver 1 according to the present embodiment includes an outer blade 22 through which multiple hair inlets 22c are formed to penetrate, and an inner blade 42 rotating while coming into sliding contact with an inner surface 22b of the outer blade 22. The rotary electric shaver 1 cuts hairs X entering the hair inlets 22c by using the outer blade 22 and the inner blade 42. The rotary electric shaver including three sets of blade units 6 configured to include the outer blade 22 and the inner blade 42 will be described as an example. However, the present invention is not limited thereto.

In FIG. 1, a reference numeral 2 represents a main body, and the main body includes a substantially columnar case 10. A switch 16 for turning on and off power and switching a usage mode is provided on a front surface of the case 10.

On the other hand, a motor that rotationally drives the inner blade 42, a battery that supplies electric power to the motor, a controller that performs a series of controls such as rotational driving of the motor, and the like are accommodated inside the case 10 (all not illustrated).

As illustrated in FIG. 2, the head unit 3 includes a head case 32 connected to and held on an upper part of the case 10 of the main body 2, a blade frame 30 covered with the head case 32 from above, a drive mechanism (not illustrated) accommodated in an inner bottom part of the head case 32, and three sets of the blade units 6 held on the blade frame 30 to be slightly movable upward and downward and to be capable of swing movement. Here, each of the blade units 6 includes a substantially disk-shaped outer blade 22, and the inner blade 42 rotating while coming into sliding contact with the inner surface 22b of the outer blade 22. In addition, the three sets of blade units 6 are disposed to form a triangle in a plan view. Although the present embodiment is an example when the blade unit 6 includes three sets as described above, a basic configuration may be similarly conceivable even when the number of sets of the blade units is other than three.

Here, the outer blade 22 is formed such that a plurality of hair inlets 22c (for example, slit-shaped, round hole-shaped, and the like, but not limited thereto) penetrating in an axial direction (that is, the same direction as the axial direction of a rotation axis of the inner blade 42), and is configured such that the inner blade 42 cuts the hairs X entering the hair inlets 22c. That is, the outer blade 22 has a configuration in which an upper surface (outer surface) 22a serves as a shaving surface that comes into contact with skin of a user, and the hair inlets 22c are open on the upper surface 22a. For example, the upper surface 22a is formed in an annular plane. In addition, the outer blade 22 has a shape in which a circumference-edge is bent downward, and an outer blade ring 24 is fitted to the circumference-edge. The outer blade 22 is fixed to the outer blade ring 24 by fitting a stopper ring 26 into an inner periphery of the outer blade ring 24.

Meanwhile, the inner blade 42 is fixed to an inner blade holder 44, and a recess part into which an upper end of an inner blade drive shaft (not illustrated) connected to an output shaft of a motor is fitted is formed in a lower part of the inner blade holder 44. The inner blade 42 is held by an inner blade receiver 46 fitted into the outer blade ring 24 to be capable of swing movement toward the outer blade 22 side, and in this manner, three sets of independent blade units 6 are formed.

Since the blade unit 6 is assembled according to the above-described configuration, the inner blade 42 (small blade 42A to be described later) is in a state of being in contact with the outer blade 22 (inner surface 22b to be described later). In this state, since the inner blade 42 is rotationally driven, the hairs X entering the hair inlets 22c can be cut by a blade edge of the inner blade 42 (small blade 42A).

The switch 16 is an operation switch for switching between turning on and off power. As an example, a push-type switch can be used. For example, the switch 16 can be set to be driven when pushed once to turn on the power, and to stop driving when pushed once more (twice in total) and turn off the power. However, the present invention is not limited to this configuration, and may adopt a configuration further including a mode for switching rotation speeds of the motor between a high speed and a low speed. In addition, a slide-type switch or the like may be used instead of the push-type switch (not illustrated).

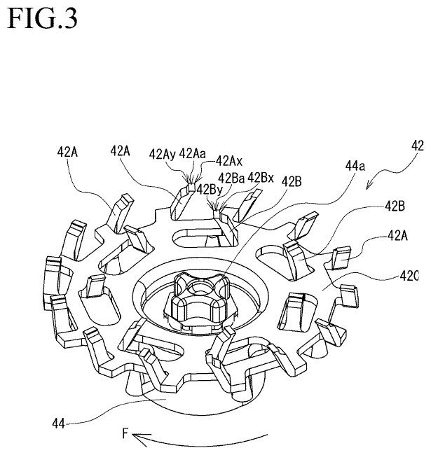

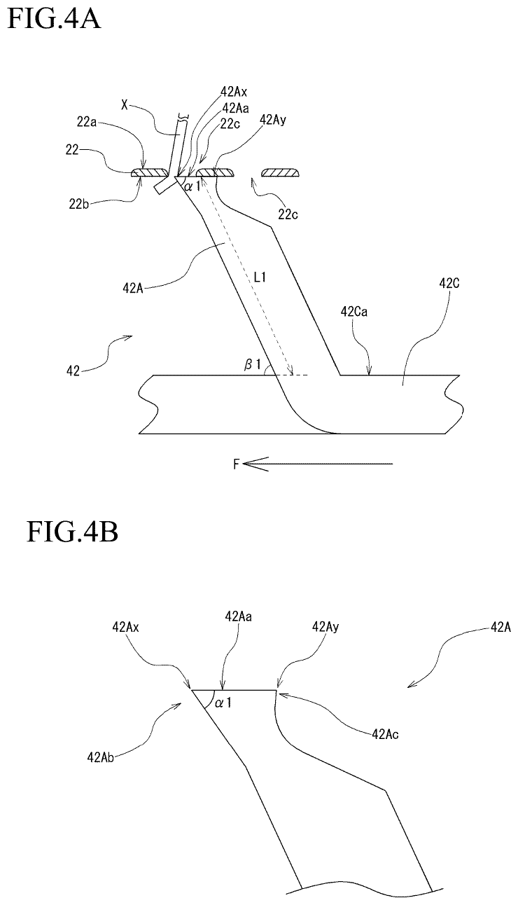

Next, a configuration of the inner blade 42 will be described in detail with reference to FIGS. 3 to 5B. FIG. 3 is a perspective view (upper surface side) of the inner blade 42. In addition, FIG. 4A is a side view of a first small blade 42A (described later) of the inner blade 42, and FIG. 4B is an enlarged view of an upper part of the first small blade 42A. In addition, FIG. 5A is a side view of a second small blade 42B (described later) of the inner blade 42, and FIG. 5B is an enlarged view of an upper part of the second small blade 42B. In each drawing, a rotation direction of the inner blade 42 is indicated as a direction of an arrow F. In addition, in order to simplify the drawing, reference numerals are assigned only to some of the small blades 42A and 42B.

As an example, the inner blade 42 is formed as an integrated structure in such a manner that die cutting and bending are performed through press working by using a flat plate-shaped metal material made of a stainless steel alloy. In this way, since the inner blade 42 can be formed with a simple structure and with fewer steps, it is possible to reduce component costs and assembly costs. However, the present invention is not limited to the integrated structure.

The inner blade 42 according to the present embodiment includes a plurality of small blades in which a part of a metal plate 42C is erected from a base surface (upper surface) 42Ca. Specifically, a so-called dual track configuration is adopted in which a plurality of first small blades 42A are provided on a circumference on an outer peripheral side and a plurality of second small blades 42B are provided on a circumference on an inner peripheral side on the base surface (upper surface) 42Ca. However, the present invention is not limited thereto, and may adopt other configurations such as a triple track in which three rows of small blades are provided (not illustrated).

Here, the first small blade 42A has a configuration in which the first small blade 42A is erected at an acute angle (angle β1 of an erection angle) from the base surface 42Ca in the rotation direction F. On the other hand, the second small blade 42B has a configuration in which the second small blade 42B is erected from the base surface 42Ca at an acute angle (angle β2 of the erection angle) in a direction opposite to the rotation direction F.

As an example, the first small blade 42A and the second small blade 42B have a substantially rectangular prism-shape having a rectangular cross section in which one side (side in a radial direction) is approximately 1 mm and the other side (side in a circumferential direction) is approximately 0.5 mm, and are formed to have lengths L1 and L2 of approximately 3 mm. However, a dimensional shape thereof is not limited. When the lengths L1 and L2 are further shortened, stiffness of the small blade 42A can be improved, and occurrence of deflection or vibration can be prevented during an operation. Therefore, cutting quality is improved.

In the first small blade 42A, a first front end blade edge 42Ax configured to cut the hairs X entering the hair inlets 22c is formed in a front end part 42Ab in the rotation direction F of an upper end part 42Aa. In addition, in the second small blade 42B, a second front end blade edge 42Bx configured to cut the hairs X entering the hair inlets 22c is formed in a front end part 42Bb in the rotation direction F of an upper end part 42Ba. In the present embodiment, the angle α1 of the rake angle of the first front end blade edge 42Ax is formed to be a relatively small (that is, relatively sharp) angle, and the angle α2 of the rake angle of the second front end blade edge 42Bx is formed to be a relatively large (that is, not relatively sharp) angle.

According to the above-described configuration, the first small blade 42A can realize a blade edge (first front end blade edge 42Ax) in which improvement in cutting quality is emphasized. In addition, the second small blade 42B can realize a blade edge (second front end blade edge 42Bx) in which damage suppression is emphasized and cutting quality is not significantly inferior to that of the first front end blade edge 42Ax. Therefore, even when the inner blade 42 is configured to rotate only in one direction (F direction) (that is, configured not to have a reverse rotation function), it is possible to provide the electric shaver 1 which can improve the cutting quality while suppressing damage.

Furthermore, when the rotation speed of the inner blade 42 can be set in a plurality of stages as an additional function, a more suitable shaving method can be selected in accordance with a user's preference, a state of the hairs (length, amount, and the like), and a state of the skin (damaged state, sensitivity, and the like).

Here, regarding settings of a specific angle in the inner blade 42 (first small blade 42A and second small blade 42B), as a result of diligent studies conducted by the present inventor, it is confirmed that a balance between an improvement in the cutting quality and damage suppression is satisfactorily taken when using the inner blade 42 in which the angle α1 is formed to be 30°≤α1≤90°and the angle α2 is formed to be 70°≤α2≤90°. Angles β1 and β2 may be appropriately set in a range of 45° to 90°.

The inner blade 42 can be configured such that the first small blade 42A and the second small blade 42B have a forward and backward symmetrical shape along the rotation direction F. That is, the first small blade 42A can adopt a configuration in which a first rear end blade edge 42Ay formed to have the same forward and backward symmetrical shape as the second front end blade edge 42Bx of the second small blade 42B is provided in a rear end part 42Ac in the rotation direction F of the upper end part 42Aa. Furthermore, the second small blade 42B can adopt a configuration in which a second rear end blade edge 42By formed to be the same forward and backward symmetrical shape as the first front end blade edge 42Ax of the first small blade 42A is provided in a rear end part 42Bc in the rotation direction F of the upper end part 42Ba.

According to this configuration, both the first small blade 42A and the second small blade 42B adopt a configuration in which the blade edge is also formed in the rear end part in the rotation direction F. Therefore, when a function of reversely rotating the inner blade 42 is additionally provided, it is possible to further increase modes having a different balance between the improvement in the cutting quality and the damage suppression, and it is possible to provide various shaving methods suitable for users.

Hitherto, the configuration of the inner blade 42 according to the representative embodiment has been described. Meanwhile, the present invention is not limited to this configuration, and may adopt the following configuration. Specifically, the present invention may adopt a configuration in which both the first small blade 42A and the second small blade 42B which are provided in inner and outer ring shapes are in erected states at an acute angle in the rotation direction, or both are in erected states at an acute angle in a direction opposite to the rotation direction (both not illustrated). In these configurations, a relationship of the above-described rake angle, that is, a configuration for satisfying α1<α2 can be adopted by adjusting the respective lengths L1 and L2 (for example, when both the first small blade 42A and the second small blade 42B are configured to be erected at the acute angle in the rotation direction, L1>L2 is satisfied). Therefore, the cutting quality can be improved while damage can be suppressed.

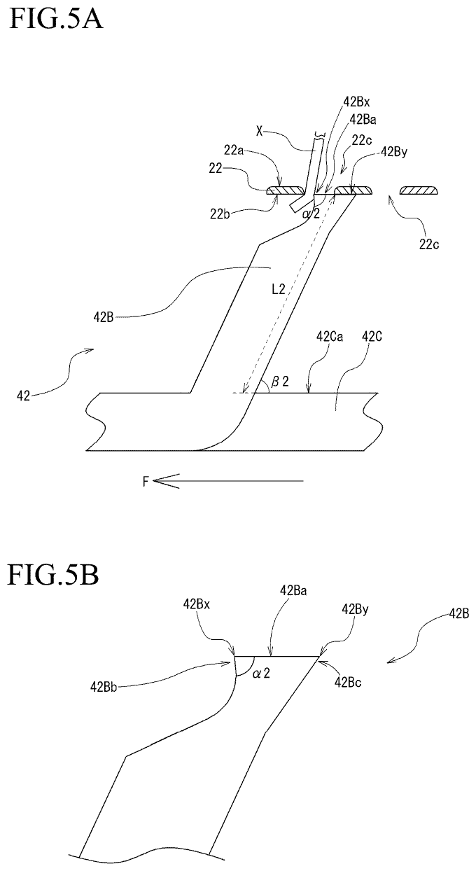

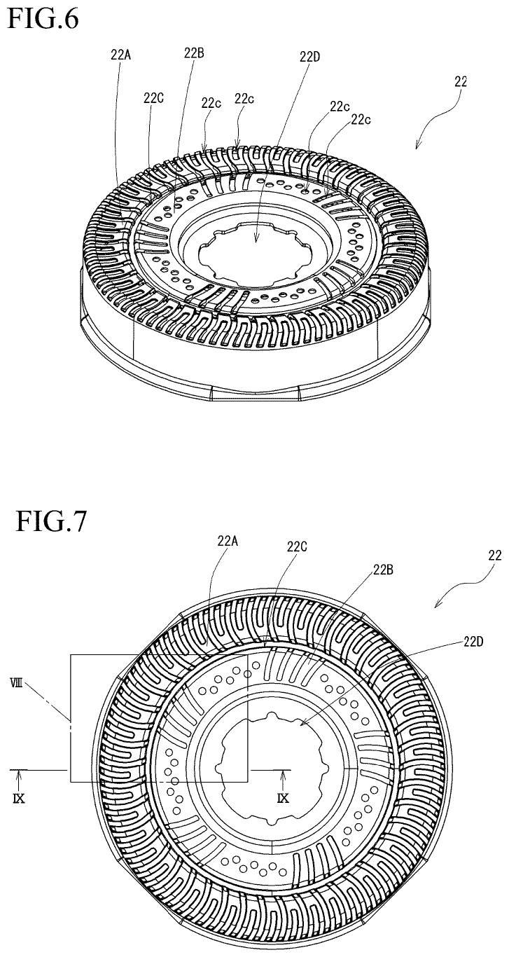

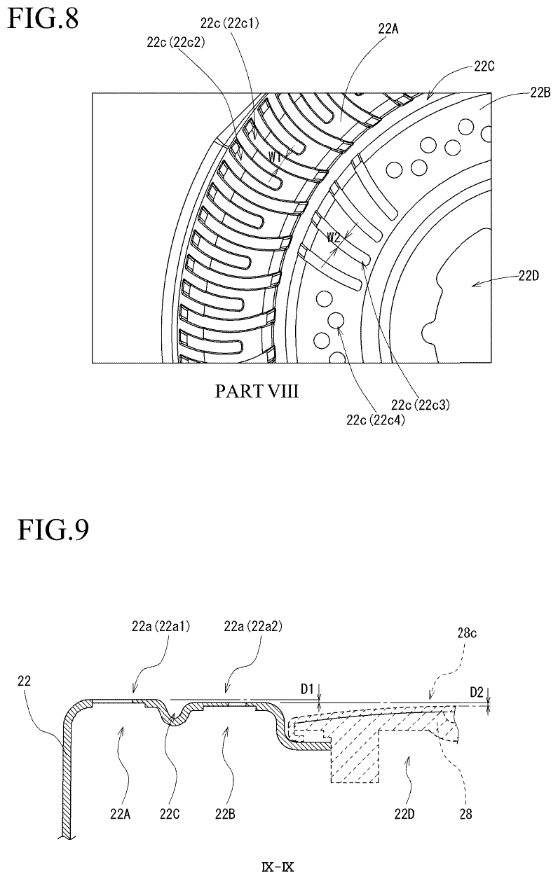

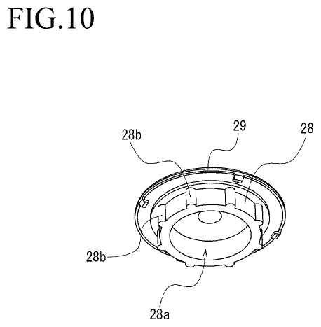

Next, a configuration of the outer blade 22 will be described in detail with reference to FIGS. 6 to 10. FIG. 6 is a perspective view (upper surface side) of the outer blade 22. In addition, FIG. 7 is a plan view of the outer blade 22. In addition, FIG. 8 is an enlarged view of a part VIII in FIG. 7. In addition, FIG. 9 is a cross-sectional view taken along line IX-IX in FIG. 7. FIG. 10 is a perspective view (lower surface side) of an outer blade cover 28. In order to simplify the drawing, reference numerals are assigned only for some of the hair inlets 22c.

As an example, the outer blade 22 is formed as an integrated structure in such a manner that processing such as die cutting, squeezing, and bending is performed through press working by using a flat plate-shaped metal material made of a stainless steel alloy, and has a substantially cup shape in which a circumference-edge is bent downward. In the present embodiment, the outer blade cover 28 formed of a resin material is fixed (fitted) to a through-hole 22D formed at a center position of the outer blade 22 in the radial direction.

On the other hand, as illustrated in FIG. 10, the outer blade cover 28 is formed in a substantially cup shape by using a resin material, and a tubular part 28a with which a protruding part 44a provided at the center position of the inner blade 42 in the radial direction is engaged is provided in a lower part of the outer blade cover 28. In addition, a plurality of projection parts 28b fitted, crimped, and fixed to the through-hole 22D of the outer blade 22 are provided on an outer wall part of the tubular part 28a. In this manner, the outer blade 22 and the outer blade cover 28 (here, the tubular part 28a) are fitted to each other in a state where a center of the outer blade 22 and a center of the outer blade cover 28 coincide with each other. A decorative plate 29 made of a metal material such as a stainless steel alloy is fitted to an upper part of the outer blade cover 28, but a configuration in which the decorative plate 29 is omitted may be adopted.

As described above, the present embodiment has a so-called dual track configuration, and the outer blade 22 has an inner and outer double annular structure in a plan view to correspond to the configuration of the inner blade 42. That is, the outer blade 22 is configured to include a first outer blades 22A provided at a position corresponding to the first small blade 42A to come into sliding contact with the first small blade 42A, a second outer blade 22B provided at a position corresponding to the second small blade 42B to come into sliding contact with the second small blade 42B, and an annular recess groove 22C provided between the first outer blade 22A and the second outer blade 22B (intermediate position in the radial direction).

Both the first outer blade 22A and the second outer blade 22B include the plurality of hair inlets 22c. As an example, the first outer blade 22A has a configuration in which slit-shaped (long hole-shaped) hair inlets 22c1 having a relatively long radial length and slit-shaped (long hole-shaped) hair inlets 22c2 having a relatively short radial length are alternately disposed in the circumferential direction. On the other hand, the second outer blade 22B has a configuration in which a group of slit-shaped (long hole-shaped) hair inlets 22c3 and a group of round hole-shaped hair inlets 22c4 are alternately disposed in the circumferential direction. However, the present invention is not limited to these configurations, and various settings for a shape, a disposition, and the like can be made.

As illustrated in FIG. 8, the outer blade 22 according to the present embodiment is formed such that a circumferential width W1 (indicating a maximum width, and here, represents a width at the center position in the radial direction) of the long hole-shaped hair inlet 22c1 provided in the first outer blade 22A is relatively narrow and a circumferential width W2 (indicating the maximum width, and here, represents the width at the center position in the radial direction) of the long hole-shaped hair inlet 22c3 provided in the second outer blade 22B is relatively wide. According to this configuration, particularly on the inner peripheral side, that is, the second outer blade 22B and the second small blade 42B can perform deep shaving, and damage can be suppressed by the shape of the second front end blade edge 42Bx of the second small blade 42B. In the present embodiment, the hair inlets 22c 1 and the hair inlets 22c2 are formed to have the same circumferential width.

In addition, as illustrated in FIG. 9, the outer blade 22 according to the present embodiment is formed such that an upper surface 22a1 of the first outer blade 22A is located at a relatively high position and an upper surface 22a2 of the second outer blade 22B is located at a relatively low position (in FIG. 9, a difference in the height dimension is indicated by D1). According to this configuration, particularly on the inner peripheral side, that is, the second outer blade 22B and the second small blade 42B can perform deep shaving, and damage can be suppressed by the shape of the second front end blade edge 42Bx of the second small blade 42B. As a modification example, the upper surface 22a1 and the upper surface 22a2 may be configured to be located at the same height.

Furthermore, in the present embodiment, an upper surface 28c (illustrated by a broken line in FIG. 9) of the outer blade cover 28 (here, including the decorative plate 29) is formed at a position lower than the upper surface 22a2 of the second outer blade 22B (in FIG. 9, a difference in the height dimension is indicated by D2). According to this configuration, the outer blade cover 28 can suppress the damage by suppressing invasive shaving on the skin, and particularly, a degree of the damage suppression can be adjusted by setting a position of the upper surface 28c. For example, as in the present embodiment, the improvement in the cutting quality and the damage suppression can be balanced at a high level by setting the upper surface 28c at the position lower than the upper surface 22a2 of the second outer blade 22B.

Here, in the studies of the present inventor, it is first confirmed that damage to the skin can be suppressed and reduced when the configuration of providing the outer blade cover 28 is adopted. The reason is considered that the outer blade cover 28 can relax contact of the outer blade 22 with the skin. However, the following fact is confirmed. When the position of the upper surface 28c of the outer blade cover 28 (here, including the decorative plate 29) is too high, for example, when the upper surface 28c is set to be higher than the position of the upper surface 22a1 of the first outer blade 22A, shaving itself cannot be sufficiently performed. Based on this finding, it is preferable to adopt a configuration in which the upper surface 28c of the outer blade cover 28 is set to be located at a position lower than the upper surface 22a1 of the first outer blade 22A. On the other hand, the following fact is confirmed. When the upper surface 28c of the outer blade cover 28 is set to be located at a position significantly and excessively lower than the upper surface 22a2 of the second outer blade 22B, the above-described skin contact relaxation effect cannot be sufficiently obtained by the outer blade cover 28, and damage to the skin cannot be suppressed or reduced. Therefore, the present inventor further studies on settings of the suitable position such that the upper surface 28c of the outer blade cover 28 is not located at the excessively low position, and finds out the followings. It is preferable to adopt a configuration in which D1 (difference in the height dimension between the upper surface 22a 1 of the first outer blade 22A and the upper surface 22a2 of the second outer blade 22B) and D2 (difference in the height dimension between the upper surface 22a2 of the second outer blade 22B and the upper surface 28 c of the outer blade cover 28) satisfy D2≤D1×3, and it is more preferable to adopt a configuration in which D1 and D2 satisfy D2≤D1×2. According to this configuration, the following problems can be solved. Specifically, as described above, there is a problem that the skin on the second outer blade 22B side is likely to be damaged since the circumferential width W2 of the hair inlets 22c3 of the second outer blade 22B is set to be wider than the circumferential width W1 of the hair inlets 22c1 of the first outer blade 22A. However, the problem can be solved, that is, the damage can be suppressed or reduced by adopting a configuration of providing the above-described height difference.

As a modification example, a configuration may be adopted in which the upper surface 28c of the outer blade cover 28 (here, including the decorative plate 29) is set to be located at a position higher than the upper surface 22a2 of the second outer blade 22B (not illustrated). That is, the upper surface 28c is set to be located at a position lower than the upper surface 22a1 of the first outer blade 22A and to be located at a position higher than the upper surface 22a2 of the second outer blade 22B. According to this configuration, an advantageous effect of suppressing damage by suppressing invasive shaving on the skin can be further achieved by the outer blade cover 28, compared to the above-described configuration.

As described above, according to the rotary electric shaver 1 in the present invention, even with a simple configuration in which the inner blade 42 rotates only in one direction (that is, a mechanism for rotating in both forward and reverse directions is not provided), it is possible to achieve both the damage suppression and the improvement in the cutting quality.

The present invention is not limited to the embodiments described above, and various modifications can be made within the scope not departing from the present invention. In particular, although the rotary electric shaver having three sets of combinations (blade units) of the outer blade and the inner blade has been described as an example, the present invention is not limited thereto. That is, the present invention may be applied to a rotary electric shaver (not illustrated) having one set or two sets of the blade units having the above-described configuration.

What is claimed is:

1. A rotary electric shaver comprising:
a blade unit including an outer blade in which a plurality of hair inlets are formed, and an inner blade rotating while coming into sliding contact with an inner surface of the outer blade, wherein
the inner blade includes a plurality of first small blades erected from a base surface, and a plurality of second small blades erected from the base surface in a direction opposite to a rotation direction,
in the first small blades, a first front end blade edge configured to cut hairs entering the hair inlets is formed in a front end part of an upper end part in the rotation direction,
in the second small blades, a second front end blade edge configured to cut the hairs entering the hair inlets is formed in a front end part of an upper end part in the rotation direction, and
an angle of a rake angle of the first front end blade edge is formed to be a relatively small angle and an angle of a rake angle of the second front end blade edge is formed to be a relatively large angle.

2. The rotary electric shaver according to claim 1, wherein
the first small blade is disposed on an outer peripheral side on the base surface,
the second small blade is disposed on an inner peripheral side on the base surface, and
the outer blade includes a first outer blade provided at a position corresponding to the first small blade and a second outer blade provided at a position corresponding to the second small blade, an upper surface of the first outer blade is formed at a relatively high position, and an upper surface of the second outer blade is formed at a relatively low position.

3. The rotary electric shaver according to claim 1, wherein the angle α1 is formed to satisfy 30°≤α1 ≤90°, and the angle is formed to satisfy 70°≤α2≤90°.

4. The rotary electric shaver according to claim 2, wherein the outer blade is formed such that a circumferential width of the hair inlet provided in the first outer blade is relatively narrow, and is formed such that a circumferential width of the hair inlet provided in the second outer blade is relatively wide.

5. The rotary electric shaver according to claim 2, wherein
the outer blade includes an outer blade cover fitted to a center position in a radial direction, and an upper surface of the outer blade cover is formed at a position lower than the upper surface of the second outer blade, and
when a difference in a height dimension between the upper surface of the first outer blade and the upper surface of the second outer blade is defined as D1, and a difference in a height dimension between the upper surface of the second outer blade and the upper surface of the outer blade cover is defined as D2, D1 and D2 are configured to satisfy D2≤D1×3.

6. The rotary electric shaver according to claim 2, wherein the outer blade includes an outer blade cover fitted at a center position in a radial direction, and an upper surface of the outer blade cover is formed at a position lower than the upper surface of the first outer blade and at a position higher than the upper surface of the second outer blade.

7. The rotary electric shaver according to claim 1, wherein
the first small blade is configured to be erected from the base surface at an acute angle in the rotation direction, and
the second small blade is configured to be erected from the base surface at an acute angle in the direction opposite to the rotation direction.

8. The rotary electric shaver according to claim 7, wherein the first small blade and the second small blade are formed in a forward and backward symmetrical shape along the rotation direction.
